(19) United States
(12) Patent Application Publication
(10) Pub. No.: US 2018/0351929 A1
(43) Pub. Date: Dec. 6, 2018

(54) SYSTEMS AND METHODS FOR ENHANCED USER AUTHENTICATION

(71) Applicant: MasterCard International Incorporated, Purchase, NY (US)

(72) Inventor: Manoneet Kohli, O'Fallon, MO (US)

(21) Appl. No.: 15/614,227

(22) Filed: Jun. 5, 2017

(51) Int. Cl. H04L 29/06; G06Q 20/40; G06Q 20/36

(52) U.S. Cl. CPC H04L 63/08; G06Q 20/36; G06Q 20/4014; H04L 63/102

(57) ABSTRACT

A user authentication (UA) computing device used for authenticating a user of a computer network using user identifier data is provided. The UA computing device includes a processor communicatively coupled to a memory device and programmed to store at least one sample user identifier and an associated account identifier. The processor is also programmed to receive an authentication request message associated with a candidate payment transaction including an input account identifier and a merchant identifier. The processor is further programmed to transmit a user authentication request message to the user including a prompt requesting the user authorize the transaction and input the user identifier for the type of payment transaction. The processor is programmed to determine that the candidate user is an authenticated user based on a response to the user authentication request message, and to transmit a response indicating the candidate user is the authentic user to the third party

### BACKGROUND OF THE DISCLOSURE

The field of the disclosure relates generally to enhancing user authentication, and more specifically to methods and systems for authenticating a user initiating a potential payment transaction with a merchant for processing over a payment network by processing a personal user identifier inputted by the user.

At least some known credit/debit card transactions involve fraudulent activity. These fraudulent transactions present liability issues to one or more parties involved in the transaction, such as an issuing bank, a merchant, an acquirer bank, a payment processing network and/or the user of the payment card. For example, the fraudulent activity may take the form of copying the card number and security code and/or user information stored on the magnetic stripe of the payment card while it is out of the control of the cardholder, which may occur when the cardholder gives the card to a waiter at a restaurant in order to pay the bill for a dinner, or some other merchant being paid for a good or service. Additionally, for example, in online transactions through a merchant web site or “card-not-present” transactions, the merchant party in the transaction may assume initial liability for certain aspects of the transaction unless, for example, certain risk-mitigating steps are taken.

As such, these parties are interested in systems and methods to reduce and prevent fraud and to improve a customer's transaction experience. One such fraud risk-mitigating step involves authenticating the cardholder before completing the transaction. For example, some payment networks engage an authentication service that performs an authentication of a suspect consumer prior to authorization of the transaction. The authentication service determines if the initiator of the transaction is the authorized user of the payment card. In addition to the authentication system, many known systems also use a fraud scoring system to detect potentially fraudulent transactions. Although known systems exist, there exists a need for more advanced authentication and fraud detection systems.

### BRIEF DESCRIPTION OF THE DISCLOSURE

In one aspect, a user authentication (UA) computing device used for authenticating a user of a computer network using user identifier data is provided. The UA computing device includes a processor communicatively coupled to a memory device. The processor is programmed to store a user profile for authenticating a user initiating a payment transaction over a computer network, the profile including at least one sample user identifier and an associated account identifier. The processor is also programmed to receive an authentication request message associated with a candidate payment transaction, the authentication request message including an input account identifier and a merchant identifier. The processor is further programmed to transmit a user authentication request message to the user when the input account identifier matches the user account identifier in the user profile, wherein the user authentication request message includes a prompt requesting the user authorize the transaction and input the user identifier for the type of payment transaction. The processor is programmed to determine that the candidate user is an authenticated user based on a response to the user authentication request message, and to transmit a response indicating the candidate user is the authentic user to the third party.

In another aspect, a computer-implemented method for authenticating a user of a computer network using user identifier data is provided. The UA computing device includes a processor in communication with a memory device. The method includes storing a user profile for authenticating a user initiating a payment transaction over a computer network, the profile including at least one sample user identifier and an associated account identifier. The method also includes receiving an authentication request message associated with a candidate payment transaction, the authentication request message including an input account identifier and a merchant identifier. The method further includes transmitting a user authentication request message to the user when the input account identifier matches the user account identifier in the user profile, wherein the user authentication request message includes a prompt requesting the user authorize the transaction and input the user identifier for the type of payment transaction. The method includes determining that the candidate user is an authenticated user based on a response to the user authentication request message, and transmitting a response indicating the candidate user is the authentic user to the third party.

In still another aspect, a non-transitory computer readable medium that includes computer executable instructions for authenticating a user of a computer network using user identifier data by a computing device is provided. When executed by a UA computing device including a processor and a memory device, the computer executable instructions cause the UA computing device to store a user profile for authenticating a user initiating a payment transaction over a computer network, the profile including at least one sample user identifier and an associated account identifier. The computer executable instructions also cause the UA computing device to receive an authentication request message associated with a candidate payment transaction, the authentication request message including an input account identifier and a merchant identifier. The computer executable instructions further cause the UA computing device to transmit a user authentication request message to the user when the input account identifier matches the user account identifier in the user profile, wherein the user authentication request message includes a prompt requesting the user authorize the transaction and input the user identifier for the type of payment transaction. The computer executable instructions cause the UA computing device to determine that the candidate user is an authenticated user based on a response to the user authentication request message, and to transmit a response indicating the candidate user is the authentic user to the third party.

### BRIEF DESCRIPTION OF THE DRAWINGS

FIGS. 1-6 show example embodiments of the methods and systems described herein.

FIG. 1 is a schematic diagram illustrating an example multi-party payment card processing system for enabling payment-by-card transactions between merchants, cardholders, and card issuers.

FIG. 2 is a simplified block diagram of an example system used for enhancing user authentication.

FIG. 3 illustrates an example configuration of a user device shown in FIG. 2, in accordance with one embodiment of the present disclosure.

FIG. 4 illustrates an example configuration of a server system shown in FIG. 2, in accordance with one embodiment of the present disclosure.

FIG. 5 is a flow chart of a process for enhancing user authentication using the system shown in FIG. 2.

FIG. 6 is a diagram of components of one or more example computing devices that may be used in the system shown in FIG. 2.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure of the system and methods to enhance user authentication while authenticating a payment by a cardholder by receiving an input user identifier from the cardholder.

As used herein, the term input user identifier includes at least one user identifier, such as, but not limited to, a passcode, a pin, a pattern code, a signature capture, a digital signature, a drawn pattern, one or more challenge questions, and a biometric sample or signature, such as fingerprints, facial recognition, or voice pattern recognition. The user may also set preferences that include restrictions on when the different user identifiers are used. Other examples of user identifiers include, but are not limited to, at least one of a low-energy infrared retinal scan, a finger vein scan, a near infrared iris scan, an optical fingerprint scan, a three-dimensional (3D) fingerprint scan, an optical palm print, a 3D facial scan, an optical facial scan, and speech recognition (including text-dependent and text-independent speech recognition).

One risk-mitigating step for addressing fraudulent cardholder transactions is cardholder authentication. For example, some payment networks (e.g., payment processors) may engage an authentication service that performs an authentication of a suspect consumer prior to authorization of a payment transaction. The authentication service may determine if the source of the transaction is the authorized user of the payment card. During such authentication, the suspect consumer (e.g., the person attempting to perform the payment card transaction with the merchant) may be presented with a user authentication response, sometimes called a “step-up challenge.” This step-up challenge generally requires the suspect consumer to provide a password or a passcode from a second factor device before the transaction will be processed. By obtaining this additional factor from the suspect consumer, the likelihood of the suspect consumer being a fraudulent consumer is reduced. However, this extra step presents an interruptive inconvenience, a barrier, or an interference to at least some legitimate consumers and subsequently causes at least some consumers to abandon legitimate transactions. These abandonments result in lost revenues to many parties, such as the merchant, the merchant acquirer, and the issuer. Thus, although this is one type of an authentication service, the systems and methods described herein include an enhanced authentication service that addresses these limitations.

In the example embodiment, a user authentication (UA) computing device associated with, or in communication with, a payment network is configured to provide an improved cardholder authentication and privacy service. When a customer enrolls in the service, the customer provides at least one authentication identifier (e.g., a pin, password, pattern code, digital signature, and biometric signatures) and account information for one or more payment accounts of the customer to the UA computing device. The authentication identifier and account information are stored by the UA computing device as user preferences in a customer profile. The user preferences are rule-based preferences that define steps to be taken for authenticating the user for accessing the user account. In the example embodiment, the customer may customize his or her profile. For example, the customer may specify a preferred type of user authentication response required. The user may also set the user authentication response required based on the type of transaction, the location, the amount of the transaction, and/or any combination of the above.

During a payment transaction with a merchant registered for the payment service, the merchant initiates the transaction by giving the customer a bill for the good or service as opposed to the cardholder giving his or her payment card to the merchant to swipe. The customer gives the merchant a customer identifier (name, username, preliminary authentication, or another unique identifier), and the merchant provides the customer identifier to the UA computing device through a point of sale (POS) device or a website ecommerce gateway that is in communication with the UA computing device to enable the UA computing device to identify the corresponding customer profile. The UA computing device analyzes the initiated transaction to determine a type of user authentication requirement to present to the customer. More specifically, based on: (i) the customer's preferences (e.g., customer profiles stored in memory), (ii) the merchant's preferences, (iii) a risk assessment performed by the UA computing device, (iv) geo location of the POS device, (v) IP address of the computing device accessing the website, (vi) preferences of the issuer bank, and/or (vii) other analytics, the UA computing device selects a type of user authentication request message to present to the customer.

In the exemplary embodiment, the user authentication request message is presented to the customer via the customer's mobile computing device and an application executing on the device. The customer is able to respond with a user authentication response message, including a user identifier and any optional additions to the bill amount (e.g., a gratuity, a tip, etc.), which is sent back to the UA computing device.

The UA computing device compares the user identifier included in the user authentication response message to the stored user identifier to determine if the customer is authenticated. In some embodiments, the UA computing device provides an additional step-up user authentication request message for transactions having a risk of fraud that is determined to be relatively high.

In some embodiments, the service includes an electronic wallet that includes a plurality of payment accounts associated with the customer. In the exemplary embodiment, the customer elects which payment account of the plurality of payment accounts to be used for specific types of transactions. In some embodiments, the UA computing device determines the payment account to use with the transaction based on the transaction itself. This determination may be based on the type of transaction, the amount of the transaction, the amount in each of the plurality of accounts, the location, and/or any potential rewards that may be earned from completing the transaction.

In a first example, a customer is dining at a restaurant. At the completion of the dining experience, the customer requests the bill for the meal. The merchant provides a folder that includes the bill and a paper form that requests that the customer provide a unique account identifier for initiating payment. After the customer has provided their unique account identifier, the merchant inputs the unique account identifier to the payment network where it is transmitted to the UA computing device as an identifier verification request. When the UA computing device receives the authentication request from the merchant and determines that the unique account identifier is associated with an enrolled customer, the UA computing device transmits a customer user authentication request message to the customer's mobile device associated with the account identifier. The user authentication request message includes the bill amount, an option to provide a gratuity amount of the customer's selection in addition to the bill, and a request for the customer's identifier. The UA computing device then receives a user authentication response message from the customer including a user identifier and any gratuity amount authorization. The UA computing device compares the input user identifier included in the user authentication response message from the customer to the sample user identifier stored in memory associated with the customer account, and transmits a response to the merchant based on the user identifier comparison, either authenticating the customer and the included gratuity amount or denying authentication. In a variation of the first example, the customer may input their unique account identifier into a merchant's point of sale device. Also, instead of providing the actual user identifier data for the comparison, a hashed or other tokenized version of the user identifier may be sent and used for the comparison for security reasons.

In a second example, a customer is traveling for work and finds a gift that she wants to buy for her spouse. The customer has set preferences requiring a fingerprint user authentication response for payment transactions over a certain amount outside of her hometown. When the UA computing device determines that the payment transaction is over the threshold and outside of the customer's hometown (e.g., from the merchant identifier and merchant location being verified or from the GPS of the cardholder device), the UA computing device transmits a fingerprint user authentication request message to the customer's mobile device. The UA computing device confirms the fingerprint prior to authenticating the customer for the payment transaction. In a variation on the second example, the customer may attempt to access the payment account using an online payment gateway, such as at an ecommerce website. The user preferences may indicate that all online transactions over a certain amount require an additional user authentication response, and the additional user identifier requirement is sent to the customer by the UA computing device.

The methods and system described herein may be implemented using computer programming or engineering techniques including computer software, firmware, hardware, or any combination or subset. As disclosed above, at least one technical problem with prior systems is that there is a need for improved payment transaction authentication to reduce fraudulent use and theft of payment card data, especially when the payment card and/or payment card data is out of the cardholder's direct control. The system and methods described herein address that technical problem. The technical effect of the systems and processes described herein is achieved by performing at least one of the following steps: (a) storing a user profile for authenticating a user initiating a payment transaction over a computer network, the profile including at least one sample user identifier and an associated account identifier; (b) receiving an authentication request message associated with a candidate payment transaction, the authentication request message including an input account identifier and a merchant identifier; (c) transmitting a user authentication request message to the user when the input account identifier matches the user account identifier in the user profile, wherein the user authentication request message includes a prompt requesting the user authorize the transaction and input the user identifier for the type of payment transaction; (d) determining that the candidate user is an authenticated user based on a response to the user identifier verification request message; and (e) transmitting a response indicating the candidate user is the authentic user to the third party. The resulting technical effect is that a remote user authentication response system separated from merchant POS devices/interfaces provides a more secure and user-friendly payment and authentication process.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. Each type of transactions card can be used as a method of payment for performing a transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX® is a registered trademark of The Open Group located in Reading, Berkshire, United Kingdom).

In a further embodiment, the system is run on an iOS® environment (iOS is a registered trademark of Apple Inc. located in Cupertino, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

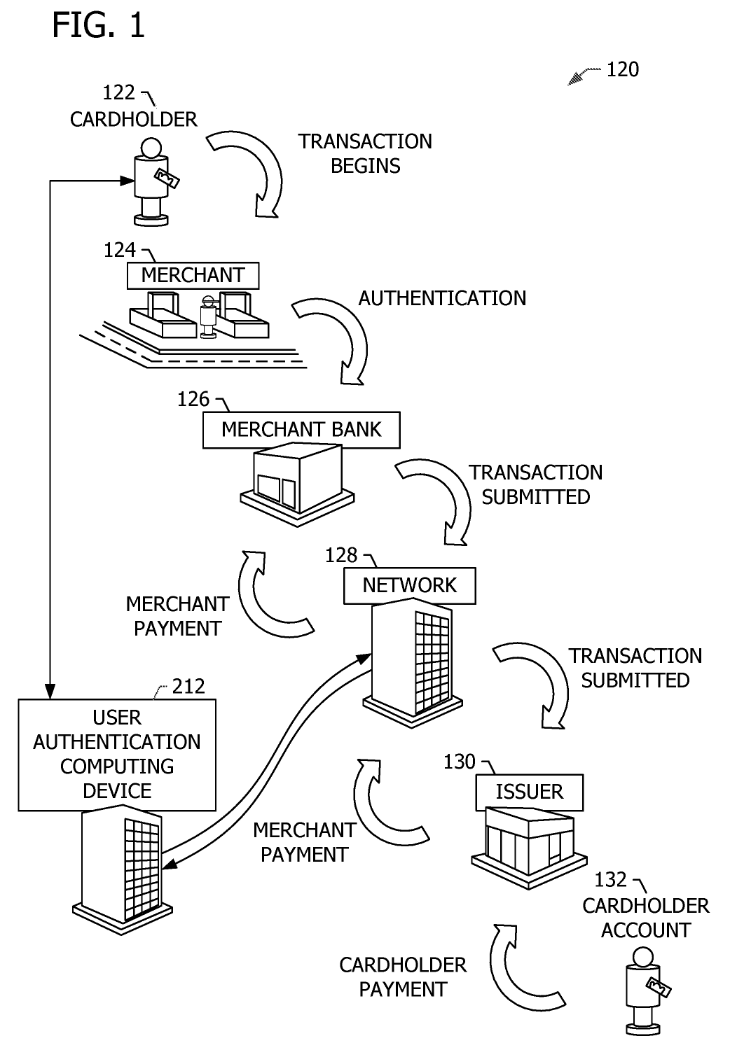

FIG. 1 is a schematic diagram illustrating an example multi-party payment card processing system 120 for enabling payment-by-card transactions between merchants 124, cardholders 122, and card issuers 130. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In the payment card processing system, a financial institution called the “issuer” issues a transaction card or electronic payments account identifier, such as a credit card, to a consumer or cardholder 122, who uses the transaction card to tender payment for a purchase from a merchant 124. To accept payment with the transaction card, merchant 124 must normally establish an account with a financial institution that is part of the financial payment system. This financial institution is usually called the “merchant bank,” the “acquiring bank,” or the “acquirer.” Cardholder 122 tenders payment for a purchase with a transaction card and merchant 124 requests authorization from a merchant bank 126 for the amount of the purchase. The request may be performed over the telephone, but is usually performed through the use of a point-of-sale terminal, which reads cardholder's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer bank 130 to determine whether cardholder's 122 account 132 is in good standing and whether the purchase is covered by cardholder's 122 available credit line. Based on these determinations, the request for authorization will be declined or accepted. If the request is accepted, an authorization code is issued to merchant 124.

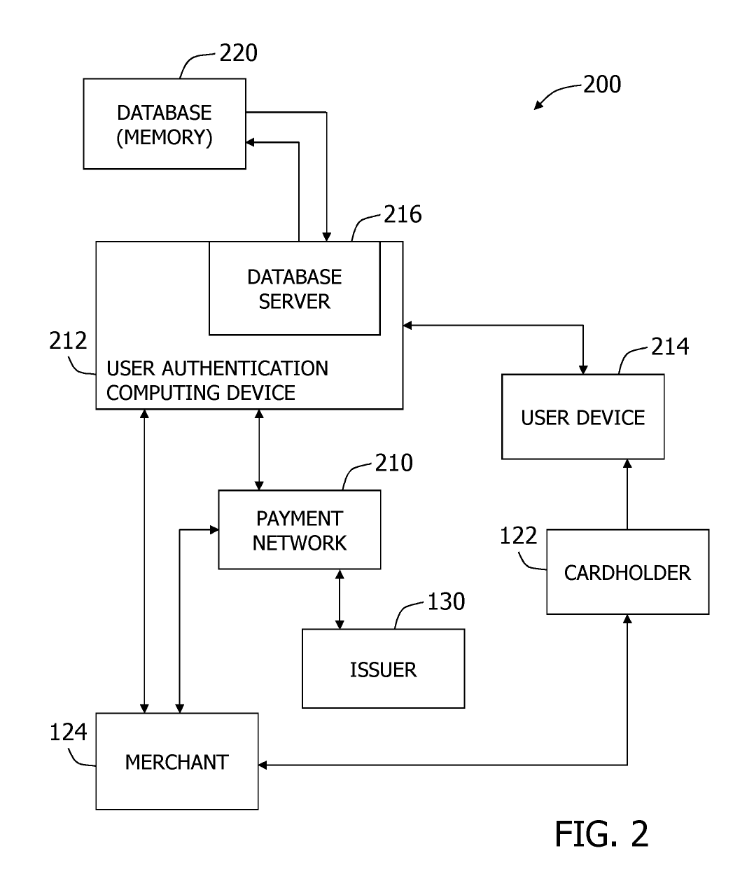

When a request for authorization is accepted, the available credit line of cardholder's 122 account 132 is decreased. Normally, a charge for a payment card transaction is not posted immediately to cardholder's 122 account 132 because bankcard associations, such as MasterCard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the point-of-sale terminal. This may include bundling of approved transactions daily for standard retail purchases. If cardholder 122 cancels a transaction before it is captured, a “void” is generated. If cardholder 122 returns goods after the transaction has been captured, a “credit” is generated. Interchange network 128 and/or issuer bank 130 stores the transaction card information, such as a category of merchant, a merchant identifier, a location where the transaction was completed, amount of purchase, date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer bank 130. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 122 purchases travel, such as airfare, a hotel stay, and/or a rental car, at least partial itinerary information is transmitted during the clearance process as transaction data. When interchange network 128 receives the itinerary information, interchange network 128 routes the itinerary information to database 220.

For debit card transactions, when a request for a personal identification number (PIN) authorization is approved by the issuer, cardholder's account 132 is decreased. Normally, a charge is posted immediately to cardholder's account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer bank 130. Settlement refers to the transfer of financial data or funds among merchant's 124 account, merchant bank 126, and issuer bank 130 related to the transaction. Usually, transactions are captured and accumulated into a “batch,” which is settled as a group. More specifically, a transaction is typically settled between issuer bank 130 and interchange network 128, and then between interchange network 128 and merchant bank 126, and then between merchant bank 126 and merchant 124.

In some embodiments, cardholder 122 registers one or more payment cards with a digital wallet. Having done this, cardholder 122 can interact with a participating online merchant 124. At the check-out stage, online merchant 124 displays a button on the merchant website which cardholder 122 can click on in order to make a payment using the cardholder's digital wallet. Online merchant 124 then redirects the user to a “switch” operated by interchange network 128. Using a cookie located on the cardholder's computer, the “switch” is able to determine which wallet-hosting server hosts a wallet associated with cardholder 122. The switch then establishes a connection between the cardholder's computer and the appropriate wallet-hosting system, which presents cardholder 122 with a sign-in page (e.g., as a pop-up window), where there is an authentication process (e.g., entry of a pre-agreed password). This log-in process may use the same login credentials (e.g., password) which the user also uses to obtain access to other online banking activities.

The wallet-hosting system then securely transfers the cardholder's payment information to the online merchant's domain. The merchant's domain submits the cardholder's payment information to acquiring bank 126 for a separate authorization process in which the acquiring domain communicates with the issuing bank 130 to ask the bank to authorize the transaction. Thus, cardholder 122 is not required to enter their card details (except at the stage of initially registering with the wallet-hosting system), and the online transaction process is streamlined with only a single redirection, and consistent branding for the entire payment process, irrespective of the online merchant 124.

In some embodiments, a unique identifier is provided to cardholder 122. The unique identifier is different from the cardholder's account number. In these embodiments, interchange network 128 stores the unique identifier in database 220 along with cardholder account 132. When interchange network 128 receives the unique identifier, interchange network 128 determines the associated cardholder account 132 and uses that information in processing the payment transaction.

In some embodiments, multi-party payment card processing system 120 includes a user authentication (UA) computing device 212 in communication with components of system 100 over interchange network 128 and cardholder 122 over a second network (e.g., the internet). In the example embodiment, UA computing device 212 is configured to improve user authentication and privacy using user identifier data, as is described below in more detail.

FIG. 2 is a simplified block diagram of an example system 200 used for improving user authentication as part of a payment transaction. In the example embodiment, system 200 may be used for performing payment-by-card transactions received as part of processing cardholder transactions. In addition, system 200 is a payment processing system that includes a UA computing device 212 configured to improve user authentication and privacy. As described below in more detail, UA computing device 212 is configured to: (i) store a user profile for authenticating a user initiating a payment transaction over a computer network, the profile including at least one sample user identifier and an associated account identifier; (ii) receive an authentication request message associated with a candidate payment transaction, the authentication request message including an input account identifier and a merchant identifier; (iii) transmit a user authentication request message to the user when the input account identifier matches the user account identifier in the user profile, wherein the user authentication request message includes a prompt requesting the user authorize the transaction and input the user identifier for the type of payment transaction; (iv) determine that the candidate user is an authenticated user based on a response to the user identifier verification request message; and (v) transmit a response indicating the candidate user is the authentic user to the third party

The resulting technical effect is that a user authentication response system for payment transactions capable of interfacing with the user separate from the merchant's POS device or payment system provides a more secure and user-friendly payment and authentication process.

In the example embodiment, user device 214 is a smartphone that includes a web browser and/or a software application the enable user device 214 to receive data from UA computing device 212 and to send data to UA computing device 212 using the internet and/or a type of data service. More specifically, user device 214 is communicatively coupled to the Internet through many interfaces including, but not limited to, at least one of a network, such as a local area network (LAN), a wide area network (WAN), or an integrated services digital network (ISDN), a dial-up-connection, a digital subscriber line (DSL), a cellular phone connection, and a cable modem. User device 214 can be any device capable of accessing the Internet including, but not limited to, a desktop computer, a laptop computer, a personal digital assistant (PDA), a cellular phone, a tablet, a phablet, or other web-based connectable equipment. In the example embodiment, cardholder 122 uses user device 214 to access a commerce website for merchant 124. In another embodiment, cardholder 122 uses user device 214 to register for an improved authentication service, to set preferences for authentication, and to access a virtual wallet.

A database server 216 is communicatively coupled to a database 220 that stores data. In one embodiment, database 220 includes user preferences, user authentication response requirements, issuer preferences, and merchant preferences. In the example embodiment, database 220 is stored remotely from UA computing device 212. In some embodiments, database 220 is decentralized. In the example embodiment, a person can access database 220 via user device 214 by logging onto UA computing device 212, as described herein.

UA computing device 212 is communicatively coupled with payment network 210. Payment network 210 represents one or more parts of payment network 120 (shown in FIG. 1). In the example embodiment, UA computing device 212 is in communication with one or more computing devices associated with interchange network 128. In other embodiments, UA computing device 212 is in communication with one or more computing devices associated with merchant 124, merchant bank 126 (shown in FIG. 1), or issuer bank 130 (shown in FIG. 1). In some embodiments, UA computing device 212 may be associated with, or is part of payment network 120, or in communication with payment network 120, shown in FIG. 1. In other embodiments, UA computing device 212 is associated with a third party and is in communication with payment network 120. In some embodiments, UA computing device 212 may be associated with, or be part of merchant bank 126, interchange network 128, and issuer bank 130. In addition, UA computing device 212 is communicatively coupled with merchant 124. In the example embodiment, UA computing device 212 is in communication with merchant 124 and user device 214 via Application Programming Interface (API) calls. Through the API call, merchant 124 may transmit information to and receive information from UA computing device 212.

In the example embodiment, UA computing device 212 is associated with a payment network 120 and is configured to provide an improved cardholder authentication and privacy service. When a customer, such as cardholder 122 shown in FIG. 1, enrolls in the service, the customer provides one or more user identifiers (e.g., a pin, password, pattern code, digital signature, and biometric signatures) and account information for one or more payment accounts of the customer to UA computing device 212. The user identifier and account information are stored by UA computing device 212 in database 220 as user preferences in a customer profile. The user preferences are rule-based preferences that define steps to be taken for authenticating the user for accessing the user account. In the example embodiment, the customer may customize his or her profile. For example, the customer may specify a preferred type of user authentication response requirement. The user may also set the user authentication response requirement required based on the type of transaction, the location, the amount of the transaction, and/or any combination of the above. The customer may also login to UA computing device 212 using a user device 214 to update or change the user preferences.

In some embodiments, UA computing device 212 may be associated with the financial transaction interchange network 128 shown in FIG. 1 and may be referred to as an interchange computer system. UA computing device 212 may be used for processing transaction data and analyzing for fraudulent transactions. In addition, at least one of user device 214 may include a computer system associated with an issuer 130 of a transaction card. Accordingly, UA computing device 212 and user device 214 may be utilized to process transaction data relating to purchases a cardholder 122 makes utilizing a transaction card processed by interchange network 128 and issued by the associated issuer 130. At least one user device 214 may be associated with a user or a cardholder 122 seeking to register, access information, or process a transaction with at least one of interchange network 128, issuer 130, or merchant 124. In addition, user device 214 may include point-of-sale (POS) devices associated with merchant 124 and used for processing payment transactions. Furthermore, user device 214 may be used by cardholders or other users to access user accounts online, such as through ecommerce gateways.

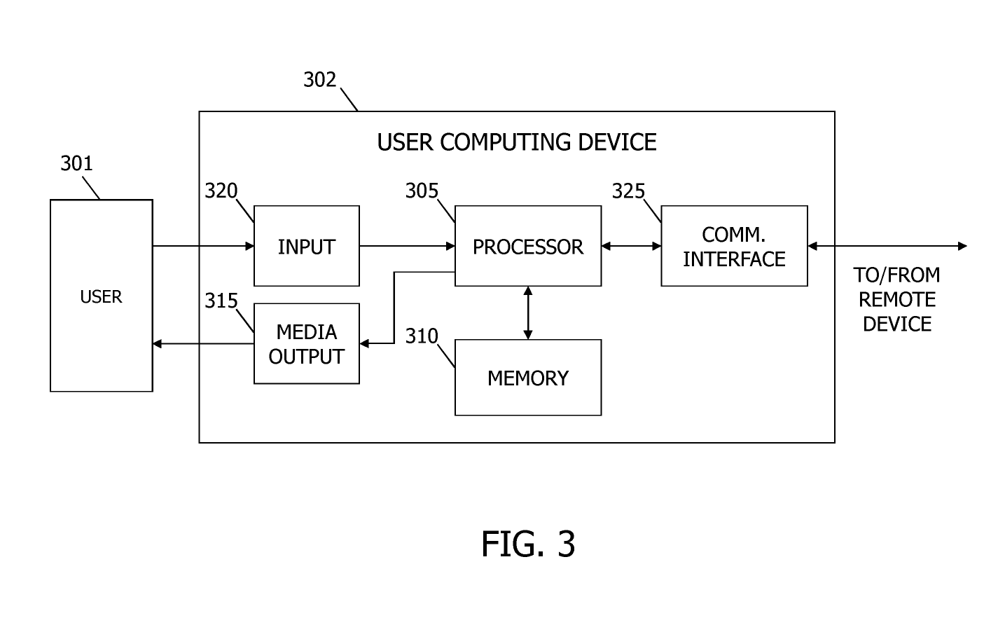

FIG. 3 illustrates an example configuration of a user device 214 shown in FIG. 2, in accordance with one embodiment of the present disclosure. User computing device 302 is operated by a user 301. User computing device 302 may include, but is not limited to, computing devices associated with cardholder 122 (shown in FIG. 1). User computing device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer-readable media.

User computing device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computing device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a camera, a gyroscope, an accelerometer, a position detector, a user identifier device, and/or an audio input device. A single component such as a touch screen may function as both an output device of media output component 315 and input device 320.

User computing device 302 may also include a communication interface 325, communicatively coupled to a remote device such as UA computing device 212 (shown in FIG. 2). Communication interface 325 may include, for example, a wired or wireless network adapter and/or a wireless data transceiver for use with a mobile telecommunications network.

Stored in memory area 310 are, for example, computer-readable instructions for providing a user interface to user 301 via media output component 315 and, optionally, receiving and processing input from input device 320. The user interface may include, among other possibilities, a web browser and/or a client application. Web browsers enable users, such as user 301, to display and interact with media and other information typically embedded on a web page or a website from UA computing device 212. A client application allows user 301 to interact with, for example, verification computing device 212. For example, instructions may be stored by a cloud service and the output of the execution of the instructions sent to the media output component 315.

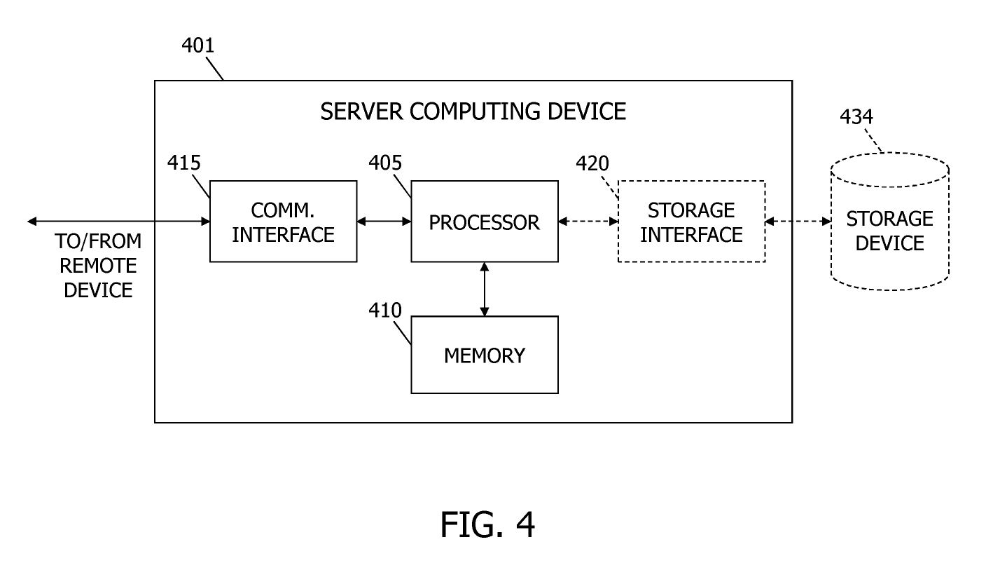

FIG. 4 illustrates an example configuration of a server system shown in FIG. 2, in accordance with one embodiment of the present disclosure. Server computing device 401 may include, but is not limited to, database server 216, merchant/website server 124, and UA computing device 212 (all shown in FIG. 2). Server computing device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computing device 401 is capable of communicating with a remote device such as another server computing device 401, user device 214, merchant/website server 124, or UA computing device 212 (all shown in FIG. 2). For example, communication interface 415 may receive requests from user device 214 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computing device 401. For example, server computing device 401 may include one or more hard disk drives as storage device 434. In other embodiments, storage device 434 is external to server computing device 401 and may be accessed by a plurality of server computing devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

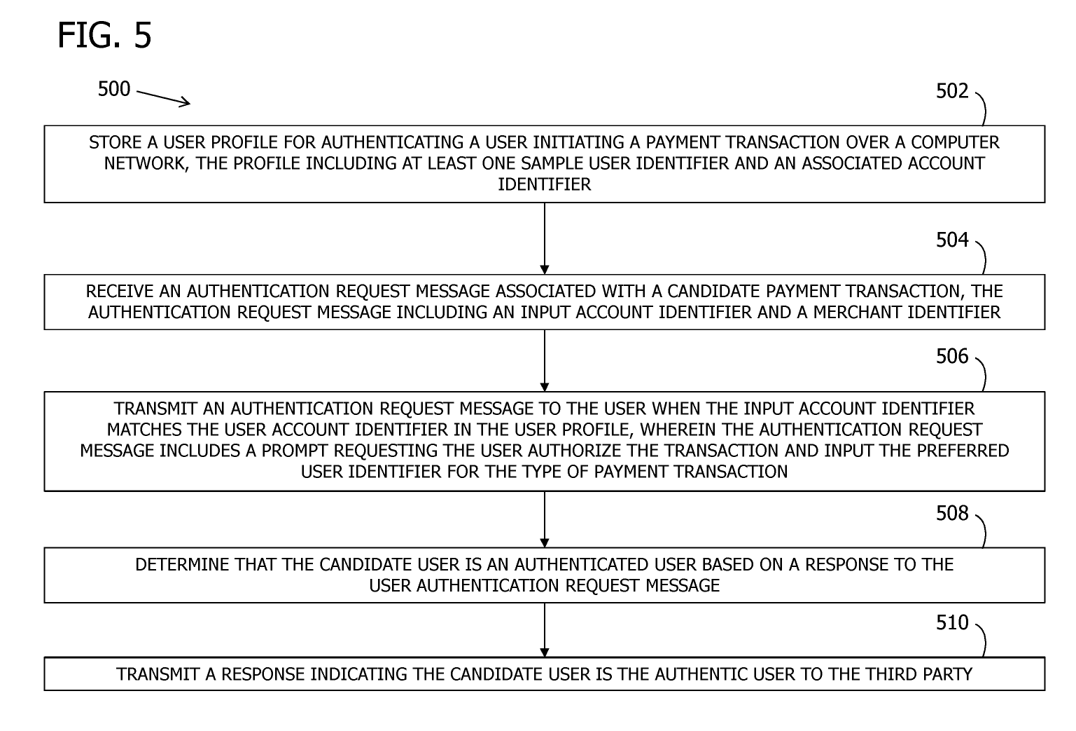

Processor 405 executes computer-executable instructions for implementing aspects of the disclosure. In some embodiments, processor 405 is transformed into a special purpose microprocessor by executing computer-executable instructions or by otherwise being programmed. For example, processor 405 is programmed with the instructions such as are illustrated in FIG. 5.

FIG. 5 is a flow chart of a process 500 for improving user authentication using system 200 shown in FIG. 2. In the example embodiment, process 500 is performed by UA computing device 212 (shown in FIG. 2).

In the example embodiment, UA computing device 212 stores 502 a user profile for authenticating a user whom is initiating a payment transaction over a computer network, the profile including at least one sample user identifier and an associated account identifier in database 220 (shown in FIG. 2). In the example embodiment, the associated account identifier includes an account identifier, such as, but not limited to, at least one of a user account number, a mobile phone number, a digital wallet identifier, and a payment card identifier. In the example embodiments, the user account is a payment card account, such as cardholder account 132 (shown in FIG. 1). In other embodiments, user account is another type of account that requires user authentication, such as, but not limited to, a loan account, a video game account, a website account, a streaming service account, or any other account that requires authenticating the user.

For example, when logging into a user account on a user computing device for the first time, a user preference may indicate that a specific user identifier be presented. In a payment transaction example, a user preference may be that the user indicates that all charges under $10 do not require a user identifier. In another payment transaction example, a user preference indicates a dollar threshold for the user identifier based on location. In this example, the user sets a $100 threshold within 5 miles of the user's residence, where transactions under this threshold amount in the approved area do not require a user identifier. However, transactions over that amount require a user identifier. The user may also require that all transactions outside of the 5 mile area require a user identifier and that transactions outside of the 5 mile area and over a threshold dollar amount require more than one user identifier or a different user identifier.

In the example embodiment, UA computing device 212 receives 504 an authentication request message associated with a candidate payment transaction, including an account identifier and a merchant identifier. In the example embodiment, the user authentication request is received from a third party, including, without limitation, a merchant conducting a payment transaction with the user. In other embodiments, the user authentication request is received from an acquirer that is attempting to access the user account. In other embodiments, the user authentication request is received from user device 214 (shown in FIG. 2).

In the example embodiment, UA computing device 212 transmits 506 a user authentication request message to the user when the input account identifier matches the user account identifier in the user profile, wherein the user authentication request message includes a prompt requesting the user authorize the transaction and input the preferred user identifier for the type of payment transaction. In the example embodiment, the user authentication request message is transmitted to user device 214 (shown in FIG. 2) to allow the user to input a user authentication response. User device 214 is configured to present the one or more preferred user identifier requests to the user. In other embodiments, the user authentication request message is transmitted to a merchant POS device to allow the user to input a user identifier to the user authentication request message. In some embodiments, user device 214 is in communication with another computing device, such as through a Near Field Communication (NFC) connection. In these embodiments, user device 214 transmits the one or more user authentication requests, as part of the user authentication request message, to the other computing device to be presented to the user attempting access.

In the example embodiment, UA computing device 212 transmits 506 at least one user identifier request, as part of the user authentication request message, based on the at least one user identifier preference stored in database 220. UA computing device 212 analyzes the at least one user identifier preference and the user authentication request to determine whether or not a user identifier is warranted to respond to the user authentication request message. If a user identifier is warranted, UA computing device 212 determines which user identifier is warranted. UA computing device 212 may base the determination of the at least one user identifier on at least one of the geographic location of the payment transaction, the transaction type, transaction volume, and amount of the payment transaction. The user may also set preferences based on transaction type, where transactions for fuel and/or parking do not require further user identifiers, or where other transaction types, such as food and jewelry, would.

In some embodiments, UA computing device 212 determines that no user authentication request message(s) is needed, such as when the transaction amount is below a certain threshold. In these embodiments, UA computing device 212 determines whether or not to authenticate the user and transmits the determination to the requestor.

In some embodiments, database 220 also contains a plurality of issuer preferences associated with the user account. The issuer preferences are rule-based preferences that define steps to be taken for authenticating the user for accessing the user account. In some embodiments, the issuer is similar to issuer bank 130 (shown in FIG. 1). In other embodiments, the issuer may be the administrator of the user accounts, such as the administrator of a webpage. The issuer preferences are similar to the user preferences, but from the issuer point of view. These preferences contain any restrictions or preferences that the issuer has on user access to the user account. For example, issuer preferences may include preferred user identifiers, thresholds for different user identifiers, and authentication rules. UA computing device 212 compares the at least one user preference with the issuer preferences to determine the one or more user identifiers based on both of the comparison and the user authentication request.

For example, in the example embodiment, the user may have a preference for user identifiers A & B and the issuer may have a preference set for user identifiers B & C. In this case, UA computing device 212 determines that the user identifier is to be B. In another example, the user has a requirement that user identifier A is required when the transaction is more than $150 and the issuer has a requirement that user identifier B is required when the transaction is more than $100. If the transaction had been $125, then the user identifier B would be transmitted to the user. In some embodiments, issuer preferences overrule user preferences. If the transaction amount had been $175, then the user identifier B would have still been transmitted to the user.

In some embodiments, database 220 also contains a plurality of requestor preferences associated with the requestor associated with the user account. The requestor preferences are rule-based preferences that define steps to be taken for authenticating the user for accessing the user account. In the example embodiment, the requestor is merchant 124 requesting access to funds in user payment account 132 (shown in FIG. 1). The requestor preferences are similar to the user preferences, but from the requestor (or merchant) point of view. These preferences contain any restrictions or preferences that the requestor has on user access to the user account. For example, requestor preferences may include preferred user identifiers, thresholds for different user identifiers, and authentication rules. UA computing device 212 compares the user preferences with the requestor preferences to determine the one or more user identifiers based on the comparison and the user authentication request. For example, the user may have a preference for user identifiers A & B and the requestor may have a preference set for user identifiers B & C. In this case, UA computing device 212 determines that the user identifier is to be B.

In another example, in the example embodiment, the user has a requirement that user identifier A is required when the transaction is more than $150 and the requestor has a requirement that user identifier B is required when the transaction is more than $100. If the transaction is for $125, then the user identifier B is transmitted to the user. In some embodiments, requestor preferences overrule user preferences. If the transaction had been for $175, then the user identifier B would still be transmitted to the user. In these embodiments, UA computing device 212 may compare the user preferences, the requestor preferences, and the issuer preferences in determining the one or more user identifiers. In some situations, where there is a conflict between the user preferences, the requestor preferences, and the issuer preferences, UA computing device 212 may include one or more rules about which preferences have priority. UA computing device 212 may also determine that multiple user identifiers are required based on the user preferences, the requestor preferences, and the issuer preferences.

In some embodiments, UA computing device 212 determines the one or more user identifiers that are included in the user authentication request message based on the capabilities of user device 214 and of a point of sale device associated with the payment transaction. For example, if user device 214 is unable to receive a biometric sample, such as a fingerprint, from candidate cardholder 122 (shown in FIG. 1), UA computing device 212 will base the determined one or more user identifiers on the POS device's capability. In that situation, UA computing device 212 may request a different user identifier that the point of sale device is capable of performing. Or UA computing device 212 may transmit the user identifier for the fingerprint to a different user device, such as a laptop, associated with candidate cardholder 122, where the user device is capable of taking an image of candidate cardholder's face for facial recognition software.

In some embodiments, cardholder 122 has a plurality of payment accounts (for payment cards) stored in a virtual wallet. In these embodiments, UA computing device 212 determines a payment account for the payment transaction based in part on the user preferences. For example, the user may have a payment card that is preferred for fuel purchases. In this example, UA computing device 212 determines that the payment transaction is for fuel and selects the preferred card for that transaction. In other embodiments, UA computing device 212 may determine the payment card to select based on a promotional rate or reward associated with the different payment cards. In some embodiments, UA computing device 212 determines which payment account to use based on the type of the payment transaction, a current balance associated with each of the payment accounts, and one or more potential rewards for using each particular payment account with the payment transaction.

In some payment transaction embodiments, UA computing device 212 receives a payment account number instead of a unique account identifier. In these embodiments, UA computing device 212 determines the unique account identifier associated with the payment account number through a lookup in database 220.

In the example embodiment, UA computing device 212 determines 508 that the candidate user is an authenticated user based on a response to the user authentication request message. UA computing device 212 analyzes any user preferences and the user authentication response requirements to determine whether or not an authentic user response message is warranted to respond to the authentication request message from the third party. Once UA computing device 212 has determined 508 that the candidate user is an authenticated user based on a response to the user authentication request message, UA computing device 212 transmits 510 a response indicating the candidate user is the authentic user to the third party.

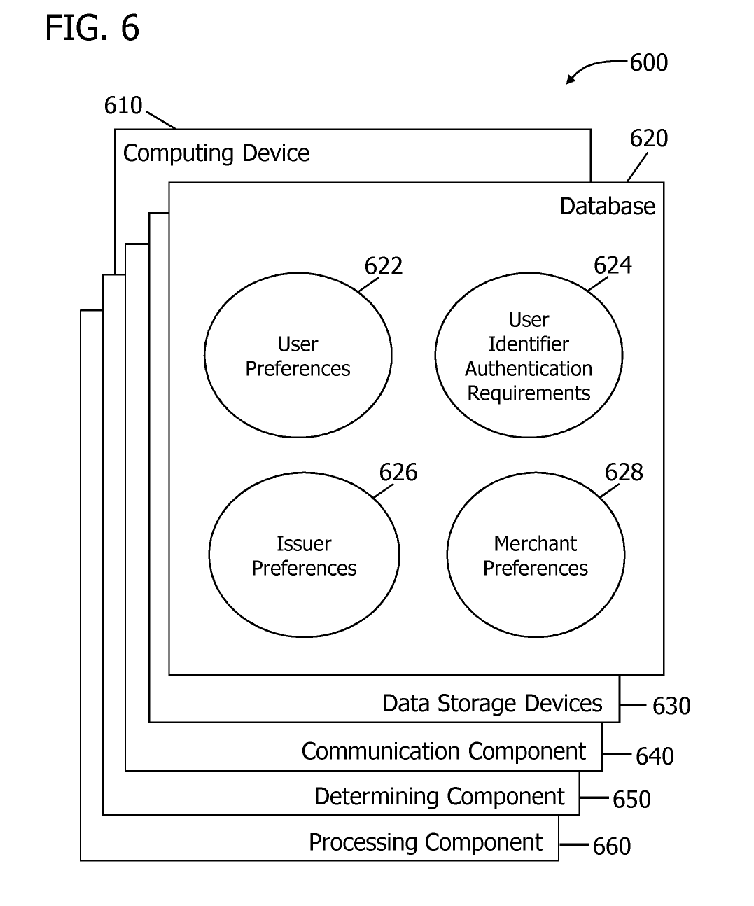

FIG. 6 is a diagram 600 of components of one or more example computing devices that may be used in system 200 shown in FIG. 2. In some embodiments, computing device 610 is similar to UA computing device 212 (shown in FIG. 2). Database 620 may be coupled with several separate components within computing device 610, which perform specific tasks. In this embodiment, database 620 includes user preferences 622, user authentication response requirements 624, issuer preferences 626, and merchant preferences 628. In some embodiments, database 620 is similar to database 220 (shown in FIG. 2).

Computing device 610 includes database 620, as well as data storage devices 630. Computing device 610 also includes a communication component 640 for receiving 504 an authentication request message and transmitting 506 a user authentication request message (both shown in FIG. 5). Computing device 610 also includes a determining component 650 for determining one or more user authentication response requirements as part of transmitting 506 a user authentication request message (shown in FIG. 5). A processing component 660 assists with execution of computer-executable instructions associated with the system.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A user authentication (UA) computing device used for authenticating a user of a computer network using user identifier data, said UA computing device comprising a processor communicatively coupled to a memory device, said processor programmed to:
store a user profile for authenticating a user initiating a payment transaction over a computer network, the profile including at least one sample user identifier and an associated account identifier;
receive an authentication request message associated with a candidate payment transaction, the authentication request message including an input account identifier and a merchant identifier;
transmit a user authentication request message to the user when the input account identifier matches the user account identifier in the user profile, wherein the user authentication request message includes a prompt requesting the user authorize the transaction and input the user identifier for the type of payment transaction;
determine that the candidate user is an authenticated user based on a response to the user authentication request message; and
transmit a response indicating the candidate user is the authentic user to the third party.

2. The UA computing device of claim 1, wherein said processor is further programmed to:
receive a user authentication response message from the user in response to the user authentication request message, wherein the user authentication response message includes at least one user identifier provided by the user; and
compare the at least one user identifier included in the user authentication response message from the user with the at least one user identifier stored in memory and associated with the user account identifier.

3. The UA computing device of claim 2, wherein the requestor is one of a merchant, an acquiring bank, and a payment network, and the user authentication request message is associated with a payment transaction.

4. The UA computing device of claim 3, wherein the payment transaction includes a user presenting a payment card from a digital wallet.

5. The UA computing device of claim 4, wherein the user authentication response message from the user includes a gratuity amount authorized by the user and associated with the payment transaction.

6. The UA computing device of claim 1, wherein the user identifier includes at least one of a low-energy infrared retinal scan, a finger vein scan, a near infrared iris scan, an optical fingerprint scan, a three-dimensional (3D) fingerprint scan, an optical palm print, a 3D facial scan, an optical facial scan, a text-independent speech recognition, a user PIN, a password, a pattern code, a passcode, a digital signature, a signature capture, a biometric signature, a biometric sample, and an answer to a challenge question.

7. The UA computing device of claim 3, wherein the user authentication response message includes geolocation data that identifies a location of the user digital wallet, said UA computing device further configured to compare the geolocation data with a location of the requestor for the payment transaction to determine whether the user digital wallet is located at the requestor location.

8. The UA computing device of claim 3, wherein transmitting the user authentication request message further comprises transmitting the user authentication request message to at least one of a point of sale device, a mobile user device, and a user computing device.

9. The UA computing device of claim 4, further comprising:
storing a plurality of user payment accounts in the digital wallet; and
determining a payment account of the plurality of payment accounts for the payment transaction based in part on a plurality of user preferences.

10. The UA computing device of claim 1, wherein the account identifier includes at least one of a user account number, a mobile phone number, a digital wallet identifier, and a payment card identifier.

11. A computer-implemented method for authenticating a user using user identifier data, the method implemented using a user authentication (UA) computing device including a processor in communication with a memory device, said method comprising:
storing a user profile for authenticating a user initiating a payment transaction over a computer network, the profile including at least one sample user identifier and an associated account identifier;
receiving an authentication request message associated with a candidate payment transaction, the authentication request message including an input account identifier and a merchant identifier;
transmitting a user authentication request message to the user when the input account identifier matches the user account identifier in the user profile, wherein the user authentication request message includes a prompt requesting the user authorize the transaction and input the user identifier for the type of payment transaction;
determining that the candidate user is an authenticated user based on a response to the user authentication request message; and
transmitting a response indicating the candidate user is the authentic user to the third party.

12. A method in accordance with claim 11 further comprising:
receiving a user authentication response message from the user in response to the user authentication request message, wherein the user authentication response message includes at least one user identifier provided by the user; and
comparing the at least one user identifier included in the user authentication response message from the user with the at least one user identifier stored in memory and associated with the user account identifier.

13. A method in accordance with claim 12, wherein the requestor is one of a merchant, an acquiring bank, and a payment network, and the user authentication request message is associated with a payment transaction.

14. A method in accordance with claim 12, wherein the payment card transaction includes a user presenting a payment card from a digital wallet.

15. A method in accordance with claim 14, wherein the user authentication response message from the user includes a gratuity amount authorized by the user and associated with the payment transaction.

16. A method in accordance with claim 12, wherein the user identifier includes at least one of a low-energy infrared retinal scan, a finger vein scan, a near infrared iris scan, an optical fingerprint scan, a three-dimensional (3D) fingerprint scan, an optical palm print, a 3D facial scan, an optical facial scan, a text-independent speech recognition, a user PIN, a password, a pattern code, a passcode, a digital signature, a signature capture, a biometric signature, a biometric sample, and an answer to a challenge question.

17. A method in accordance with claim 13, wherein the user authentication response message includes geolocation data that identifies a location of the user digital wallet, said UA computing device further configured to compare the geolocation data with a location of the requestor for the payment transaction to determine whether the user digital wallet is located at the requestor location.

18. A method in accordance with claim 13, wherein transmitting the user authentication request message further comprises transmitting the user authentication request message to at least one of a point of sale device, a mobile user device, and a user computing device.

19. A method in accordance with claim 14, further comprising:
storing a plurality of user payment accounts in the digital wallet; and
determining a payment account of the plurality of payment accounts for the payment transaction based in part on a plurality of user preferences.

20. A method in accordance with claim 11, wherein the account identifier includes at least one of a user account number, a mobile phone number, a digital wallet identifier, and a payment card identifier.

21. A non-transitory computer readable medium that includes computer executable instructions for authenticating a user using user identifier data by a computing device, wherein when executed by a user authentication (UA) computing device including a processor and a memory device, the computer executable instructions cause the UA computing device to:
store a user profile for authenticating a user initiating a payment transaction over a computer network, the profile including at least one sample user identifier and an associated account identifier;
receive an authentication request message associated with a candidate payment transaction, the authentication request message including an input account identifier and a merchant identifier;
transmit a user authentication request message to the user when the input account identifier matches the user account identifier in the user profile, wherein the user authentication request message includes a prompt requesting the user authorize the transaction and input the user identifier for the type of payment transaction;
determine that the candidate user is an authenticated user based on a response to the user authentication request message; and
transmit a response indicating the candidate user is the authentic user to the third party.

22. A non-transitory computer readable medium in accordance with claim 21, wherein the executable instructions further cause the UA computing device to:
receive a user authentication response message from the user in response to the user authentication request message, wherein the user authentication response message includes at least one user identifier provided by the user; and
compare the at least one user identifier included in the user authentication response message from the user with the at least one user identifier stored in memory and associated with the user account identifier.

23. A non-transitory computer readable medium in accordance with claim 22, wherein the requestor is one of a merchant, an acquiring bank, and a payment network, and the user authentication request message is associated with a payment transaction.

24. A non-transitory computer readable medium in accordance with claim 22, wherein the payment card transaction includes a user presenting a payment card from a digital wallet.

25. A non-transitory computer readable medium in accordance with claim 24, wherein the user authentication response message from the user includes a gratuity amount authorized by the user and associated with the payment transaction.

26. A non-transitory computer readable medium in accordance with claim 22, wherein the user identifier includes at least one of a low-energy infrared retinal scan, a finger vein scan, a near infrared iris scan, an optical fingerprint scan, a three-dimensional (3D) fingerprint scan, an optical palm print, a 3D facial scan, an optical facial scan, a text-independent speech recognition, a user PIN, a password, a pattern code, a passcode, a digital signature, a signature capture, a biometric signature, a biometric sample, and an answer to a challenge question.

27. A non-transitory computer readable medium in accordance with claim 23, wherein the user authentication response message includes geolocation data that identifies a location of the user digital wallet, said UA computing device further configured to compare the geolocation data with a location of the requestor for the payment transaction to determine whether the user digital wallet is located at the requestor location.

28. A non-transitory computer readable medium in accordance with claim 23, wherein transmitting the user authentication request message further comprises transmitting the user authentication request message to at least one of a point of sale device, a mobile user device, and a user computing device.

29. A non-transitory computer readable medium in accordance with claim 24, further comprising:
storing a plurality of user payment accounts in the digital wallet; and
determining a payment account of the plurality of payment accounts for the payment transaction based in part on a plurality of user preferences.

30. A non-transitory computer readable medium in accordance with claim 21, wherein the account identifier includes at least one of a user account number, a mobile phone number, a digital wallet identifier, and a payment card identifier.
